(19) United States
(12) Patent Application Publication
(10) Pub. No.: US 2014/0222508 A1
(43) Pub. Date: Aug. 7, 2014

(54) DATA EDITING DEVICE AND PROGRAM

(71) Applicant: Toshiba Tec Kabushiki Kaisha, Tokyo (JP)

(72) Inventors: DAIGO KUDOU, Tokyo (JP); Yoshimitsu Ohtaka, Shizuoka-ken (JP)

(73) Assignee: Toshiba Tec Kabushiki Kaisha, Tokyo (JP)

(21) Appl. No.: 14/171,501

(22) Filed: Feb. 3, 2014

(30) Foreign Application Priority Data
Feb. 7, 2013 (JP) 2013-022612

(51) Int. Cl. G06Q 30/02

(52) U.S. Cl. CPC G06Q 30/0202
USPC 705/7.31

(57) ABSTRACT

A device for generating a user interface for sales planning includes a data display generation unit configured to generate a graphical user interface (GUI) for an external device, the GUI including a data display area for displaying product sales data for a plurality of items that are included in a selected sales plan, the data display area having a first field that is editable and a second field that displays predicted sales data values which are updated when the first field is edited, a data aggregation unit configured to aggregate product sales data of the plurality of items, and a prediction calculation unit configured to calculate the predicted sales data values and update the predicted sales data values when the first field is edited, based on the product sales data for the plurality of items that have been aggregated in the data aggregation unit.

### CROSS-REFERENCE TO RELATED APPLICATION

This application is based upon and claims the benefit of priority from Japanese Patent Application No. 2013-022612, filed Feb. 7, 2013, the entire contents of which are incorporated herein by reference.

### FIELD

Embodiments described herein relate generally to a data editing device and a program.

### BACKGROUND

In the related art, purchase (sales) data for each product can be easily collected with a point-of-sale (POS) system. Such purchase data for each product is used for demand prediction of each product in a retail store or the like. The demand prediction obtained by analyzing the purchase data can be used to reduce disposal loss of unsold products caused by an excessive ordered amount, or reduce occurrence of opportunity loss due to stock-out caused by insufficient ordered amount. In addition, such demand prediction is combined with computerization of business-to-business transactions due to electronic data interchange (EDI) used, for example, in an automatic order system.

In a large-scale retail store such as a supermarket, a so-called bargain sale operation is performed which provides particular products at low cost for a limited date and time for attracting customers. It is hard to understand effects of the bargain sale operation only by visual recognition or experimental knowledge. Thus it is necessary to objectively understand how much the bargain sale induced purchase of other products, or how much the bargain sale contributed to overall sales in the entire store.

As a prediction method of effects obtained by the bargain sale operation, a method of verifying effects obtained by the bargain sale operation, by calculating a predicted quantity of purchases or predicted sales proceeds is considered.

However, input of various data items is necessary when predicting the effects obtained by the bargain sale operation, and therefore it is desirable to simplify the data input.

### DESCRIPTION OF THE DRAWINGS

FIG. 1 is a block diagram showing a configuration of a demand prediction system, according to an embodiment.

FIG. 2 is a configuration diagram of a module of a computer.

FIG. 3 is a block diagram showing a system configuration of a head office including a demand prediction device, according to the embodiment.

FIG. 4 is a front view showing an example of a demand prediction setting screen, according to the embodiment.

FIG. 5 is a flowchart showing a flow of an updating process of bargain sale plan data, according to the embodiment.

FIG. 6 is a front view showing an example of a demand prediction setting screen, according to the embodiment.

FIG. 7 is a front view showing another example of a demand prediction setting screen.

FIG. 8 is a front view showing another example of a demand prediction setting screen.

FIG. 9 is a front view showing another example of a demand prediction setting screen.

FIG. 10 is a front view showing another example of a demand prediction setting screen.

FIG. 11 is a front view showing another example of a demand prediction setting screen.

FIG. 12 is a front view showing another example of a demand prediction setting screen.

### DETAILED DESCRIPTION

In general, according to one embodiment, there is provided a device for generating a user interface for sales planning including a data display generation unit configured to generate a graphical user interface (GUI) for an external device, the GUI including a data display area for displaying product sales data for a plurality of items that are included in a selected sales plan, the data display area having a first field that is editable and a second field that displays predicted sales data values which are updated when the first field is edited, a data aggregation unit configured to aggregate product sales data of the plurality of items, and a prediction calculation unit configured to calculate the predicted sales data values and update the predicted sales data values when the first field is edited, based on the product sales data for the plurality of items that have been aggregated in the data aggregation unit.

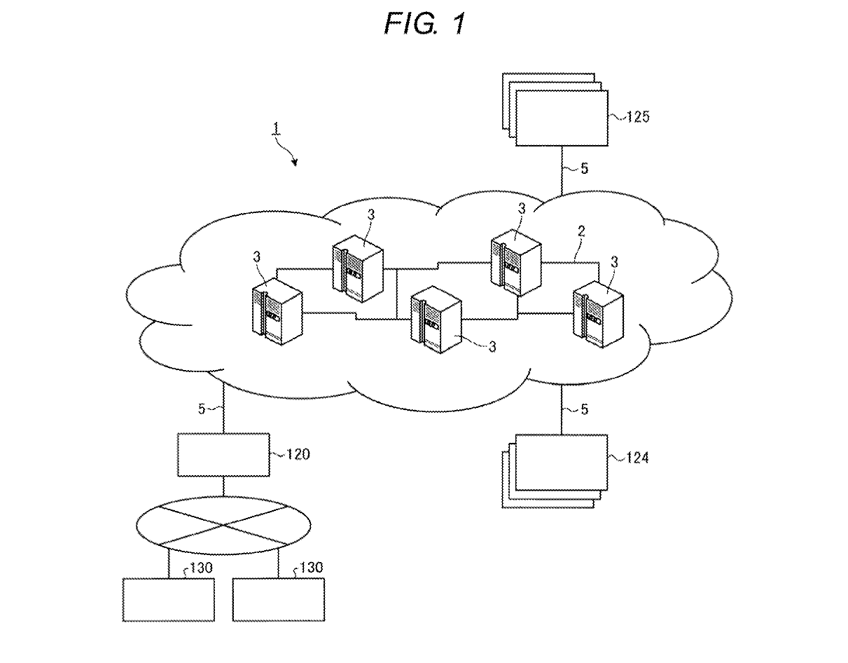

FIG. 1 is a block diagram showing a configuration of a demand prediction system 1 according to an embodiment. As shown in FIG. 1, the demand prediction system 1 includes a plurality of bargain sale planning terminals 124 and store order terminals 125 (each of which is provided in a different store) The plurality of bargain sale planning terminals 124 and store order terminals 125 are connected with a head office system which is formed by a plurality of computers 3 electrically connected to each other through a wired or wireless communication line 2, through a wired or wireless communication line (for example, Internet or LAN) 5.

In the demand prediction system 1 of the embodiment, the plurality of computers 3 function as application servers or database servers which provide a predetermined service (application). In addition, the bargain sale planning terminals 124 or the store order terminals 125 function as clients which receive the service. The demand prediction system 1 provides the service (application) in a format of Software as a Service (SaaS), for example. The demand prediction system 1 may have a format of a server client.

The head office system is connected to a store server 120 which connects a plurality of point-of-sale (POS) terminals 130 through the wired or wireless communication line (for example, Internet or LAN) 5.

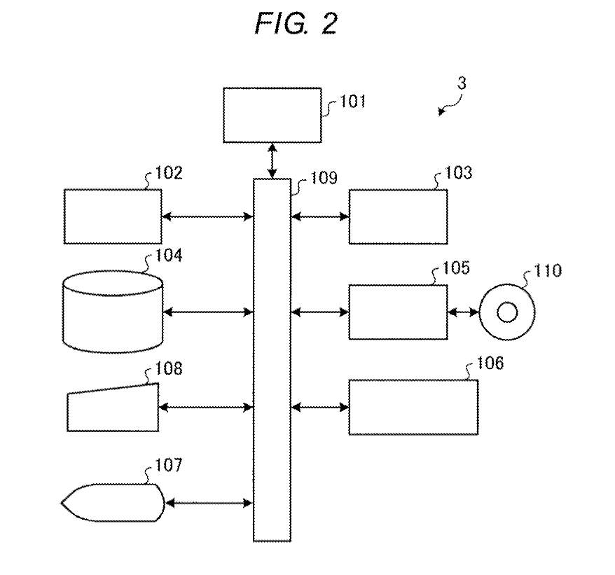

The computer 3, the bargain sale planning terminal 124, and the store order terminal 125 described above are general personal computers. The bargain sale planning terminal 124 or the store order terminal 125 may be a tablet terminal. Herein, the computer 3 will be described as an example. FIG. 2 is a configuration diagram of modules of the computer 3. As shown in FIG. 2, the computer 3 includes a central processing unit (CPU) 101 which performs information processing, a read only memory (ROM) 102 which stores a BIOS or the like, and a random access memory (RAM) 103 which rewritably stores various data items.

In addition, the computer 3 includes a hard disk drive (HDD) 104 which is a memory unit which functions as various databases and stores various programs, a medium reading device 105 such as a DVD drive (for holding information, distributing information to outside, or acquiring information from the outside using a storing medium 110), a communication control device 106 for transmitting information with another external device through each communication line, a display unit 107 such as a liquid crystal display (LCD) which displays process results or effects thereof to an operator, and an input unit 108 which is an input device such as a keyboard or a mouse for inputting commands or information to the CPU 101 by an operator.

In addition, in the computer 3, data which is received from and transmitted to each unit described above is controlled by a bus controller 109.

In such a computer, when an operator turns on the power, the CPU 101 activates a program (such as a loader in the ROM 102) and makes the RAM 103 read an operating system (OS) which manages hardware and software of the computer from the HDD 104. The OS activates a program, reads or stores information according to manipulation of an operator. An example OS is Microsoft Windows®. An operation program which is operated in the OS is called an application program. The application program is not limited to be operated in the predetermined OS, and may cause the OS to execute a part of various processes which will be described later, or may be included as a part of a group of program files configuring predetermined application software or the OS.

A personal computer may be provided as the bargain sale planning terminal 124 or the store order terminal 125 which functions as a client, and as the computer 3 (application server or database server) depending on the difference in application programs stored in the HDD 104.

A web browser—or plug-in which is provided using a plug-in format with respect to a web browser—is installed as the application program in the head office bargain sale plan terminal 124 or the store order terminal 125. An example plug-in is Microsoft Silverlight®. Microsoft Silverlight® provides a framework for displaying animation or graphics on a browser or video reproduction, after installation.

In general, the application program to be installed in the HDD 104 of the computer is stored in the storing medium 110 which includes various types of optical media such as a CD-ROM or a DVD, various magneto-optical disks, various magnetic disks such as a flexible disk (FD), and a semiconductor memory, and the operation program stored in the storing medium 110 is installed in the HDD 104. Accordingly, the storing medium 110 having portability such as an optical information storing medium such as a CD-ROM or a DVD or a magnetic medium such as an FD can also be the storing medium for storing the application program. In addition, the application program may be acquired from the outside through the communication control device 106, for example, to be installed in the HDD 104.

When the application program is activated, the CPU 101 executes various arithmetic processes and control of each unit according to the application program.

Hereinafter, a demand prediction process which is the featured process of the embodiment, among various arithmetic processes which each CPU 101 of each computer 3 of the head office system executes through the application program, will be described.

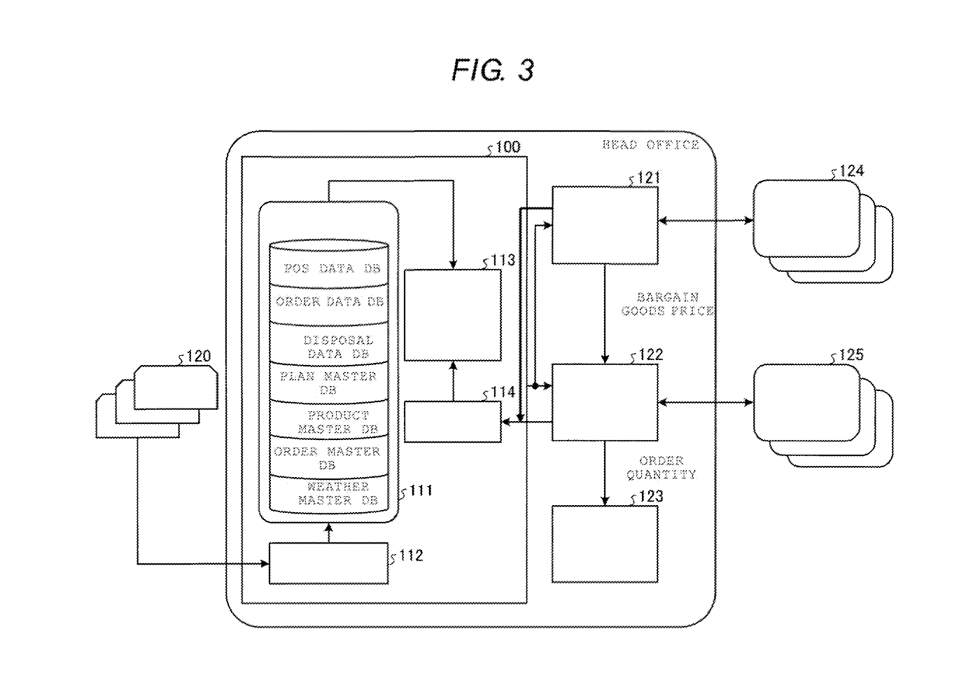

Herein, FIG. 3 is a block diagram showing a head office system configuration including a demand prediction device 100. As shown in FIG. 3, the CPU 101 of each computer 3 of the head office system implements the functions of the demand prediction device 100 (which is a data editing device), a bargain sale plan supporting system 121, an order quantity determination supporting system 122, and an order system 123 by executing the application program.

The order quantity determination supporting system 122 which can also be called a subsystem, is connected to each terminal and functions as an interface for each staff member and the demand prediction device 100 of the head office.

The bargain sale plan supporting system 121 is a system for supporting a bargain sale plan, and is connected to the plurality of bargain sale planning terminals 124 by which the bargain sale plan is managed. The bargain sale plan is, for example, a sale plan created by a staff member for a buyer of each product category, in the head office of the supermarket. The bargain sale planning terminals 124 receive input of promotion data of the bargain sale plan (such as a bargain goods code (name), bargain sale price, bargain day, leaflet printing, types of plans, display position, or the like which indicates a product which is a bargain sale target) from the staff member. The bargain sale plan supporting system 121 outputs input information to an input receiving unit 114 of the demand prediction device 100, when performing prediction of the demand.

The order quantity determination supporting system 122 is connected to the plurality of store order terminals 125 which determine an order quantity of the bargain goods and regular goods which are sold at normal cost. The store order terminal 125 is a device to which a staff member ordering in a store inputs an order quantity of the bargain goods and the regular goods by referring to the past results or the recommended information. The order quantity determination supporting system 122 is a system for determining the order quantity of each store by performing communication with the store order terminal 125 of each store. The order system 123 is a system which makes a request to an operator who manufactures and sells products for an order of the products, according to the order quantity of all stores determined by the order quantity determination supporting system 122.

The order system 123 (which is an external system which cooperates with the demand prediction device 100), receives order data such as product codes of the bargain goods and regular goods, the order quantity, a delivery date, a buying price, and the like, and transmits the order data to a wholesale dealer or a manufacturer.

The demand prediction device 100 includes a memory unit 111, a data aggregation unit 112, a prediction calculation unit 113, and the input receiving unit 114.

The memory unit 111 includes a POS data database, an order data database, a disposal data database, a plan master database, a product master database, an order master database, and a weather data database. The memory unit 111 also manages information used in another terminal or system, other than the demand prediction device 100. In addition, the memory unit 111 may be embedded in the demand prediction device 100, or may be provided outside to have a configuration different from the demand prediction device 100 as a database server.

The POS data database manages POS data of each store that is printed on a receipt or the like. The order data database manages order data of products of each store. The disposal data database manages disposal data of products of each store.

The product master database manages product basic data such as a product code, a product name, product classification, and the like. The plan master database manages bargain sale plan data such as a bargain goods code, a bargain price, a bargain day, leaflet printing, and the like. The order master database manages basic order data such as a product code, an order lot, and the like.

The weather data database stores past weather data and weather forecast data such as temperature, humidity, precipitation amount, and the like.

As described above, in the head office of a retail company which supervises the work of the plurality of stores, each database of the memory unit 111 collectively manages information necessary for each store or the head office.

The data aggregation unit 112 aggregates the POS data, the order data, the disposal data, and the like which are transmitted from each store and stores the aggregated data in the POS data database, the order data database, and the disposal data database, respectively. For example, the data aggregation unit 112 executes a daily aggregation process after closing of each store. In addition, the data aggregation unit 112 collects each of the past weather data and the weather forecast data and stores the data in the weather data database.

The prediction calculation unit 113 calculates the predicted quantity of purchase of the products which may be sold in a predetermined period based on the past predetermined period described above. That is, the predicted quantity of purchase of the products which may be sold in a predetermined period is calculated from the current point, for each product based on the POS data which is stored in the memory unit 111 and data which is variable factors such as the bargain sale plan data.

The input receiving unit 114 receives input of the data which becomes variable factors later, from the order quantity determination supporting system 122 or the bargain sale plan supporting system 121. By setting vectors (for example, selling price, date, holiday, temperature, precipitation, regional event, absence or presence of leaflet printing) derived from the input data which becomes variable factors in the prediction calculation unit 113, the predicted quantity of the purchase based on the bargain sale plan or the like can be calculated.

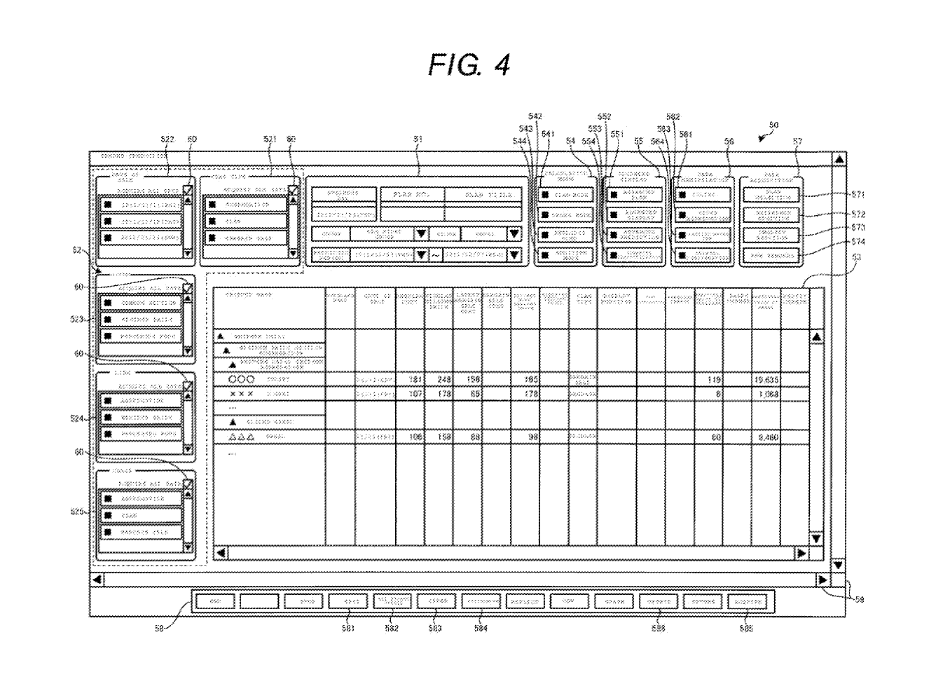

The input receiving unit 114 generates a demand prediction setting screen 50 (see FIG. 4) which is an editing screen, and transmits this demand prediction setting screen 50 with respect to the bargain sale planning terminals 124 or the store order terminals 125 (which are external devices).

FIG. 4 is an example of the demand prediction setting screen 50. As shown in FIG. 4, the demand prediction setting screen 50 includes a basic information area 51, an acquisition and display data selection area 52, a data display area 53, a calculation mode button area 54, an advanced display button area 55, a data manipulation button area 56, a data acquisition/removal button area 57, a navigation button area 58, and a scroll bar 59.

A system date (business day), an acquisition group and a store of modification target prediction data selected from a list, an acquisition period of modification target prediction data selected from a list, and a plan number and a plan title of the bargain sale plan, are displayed in the basic information area 51.

Buttons for selecting desired data acquisition and data display are provided in the acquisition and display data selection area 52. Buttons for the bargain sale, M&M, aggregation, plans, and the like are displayed in a plan type selection button 521. Buttons corresponding to all dates in the prediction period and a date of sale which is the data of the data display area 53 are displayed in a date of sale selection button 522. Buttons corresponding to product classification categories (level 3: section) are displayed in a section selection button 523. Buttons corresponding to product classification categories (level 2: line) are displayed in a line selection button 524. Buttons corresponding to product classification categories (level 1: class) are displayed in a class section selection button 525. An “all selection” button 60 which can extract and display all data is provided in each of the selection buttons 521 to 525. The buttons displayed in each of the selection buttons 521 to 525 of the acquisition and display data selection area 52 are generated from target columns of the data display area 53.

As main display items, data items (for example, bargain sale plan data) including various types of items such as a “standard name”, a “date of sale”, a “regular cost”, a “regular selling price”, a “latest bargain sale cost”, a “bargain sale cost”, a “recommended selling price”, a “modified selling price”, a “plan type”, a “display position”, a “plan confirmation”, a “purchase change”, a “predicted value of purchase”, a “sales change”, a “predicted value of sales”, and a “profit change” are displayed in the data display area 53.

Buttons that are selected when making changes in a display item or an item which is editable in the data display area 53 are provided in the calculation mode button area 54. A plan mode button 541 is a button for modification and confirmation of the bargain sale plan. This is selected when making a change in the selling price or the plan type. An order mode button 542 is a button for modification and confirmation of the order quantity with respect to the products planned for the bargain sale. An analysis mode button 543 is a button for abnormal prediction accuracy extraction and factor selection. An addition mode button 544 is a button for product addition from the product master database and new product input. In the embodiment disclosed herein, only single selection can be performed with the plan mode button 541, the order mode button 542, the analysis mode button 543, and the addition mode button 544.

Buttons for switching the display items of the data display area 53 from “main item display” to “all related items display” are provided in the advanced display button area 55. An advanced plan button 551 sets bargain sale discount, M&M, the plan number, the plan title, and the like as display items. An advanced display button 552 sets the number of small quantity displays, the number of average displays, the number of large quantity displays, and the like as display items. An advanced prediction button 553 sets profit prediction, prediction accuracy, and the like as display items. An advanced classification button 554 sets a classification code, a product code, and the like as display items. In the embodiment disclosed herein, multiple selections can be performed with the advanced plan button 551, the advanced display button 552, the advanced prediction button 553, and the advanced classification button 554.

Buttons for performing manipulation with respect to the data display area 53 are provided in the data manipulation button area 56. A filter button 561 is a button for performing setting of a filter. A store aggregation button 562 is a button for performing store aggregation. A classification row button 563 is a button for switching display or non-display of a classification row. An overall confirmation button 564 is a button for performing the plan confirmation or order approval/removal with respect to all read unapproved products. In addition, multiple selections can be performed with the filter button 561, the store aggregation button 562, the classification row button 563, and the overall confirmation button 564.

Buttons for performing manipulation with respect to the data display area 53 from a dialog box are provided in the data acquisition/removal button area 57. A plan selection button 571 is a button for acquiring the plan number and the plan period of the bargain sale plan from the plan master database, and setting those in the prediction period. A reference addition button 572 is a button for acquiring reference data from all stores and entire periods. A product addition button 573 is a button for reading additional products from the product master database. A row removal button 574 is a button for removing the read reference and additional data by designating store, period, and product classifications.

An editing button 581, an “all stores updating” button 582, an order button 583, a distribution button 584, an acquisition button 585, an updating button 586, and the like are provided in the navigation button area 58. The editing button 581 is a button for selecting editing of the displayed data in the data display area 53. The “all stores updating” button 582 is a button for selecting the data updating with respect to all store data items. The order button 583 is a button for selecting ordering with the order data after approving of the order quantity. The distribution button 584 is a button for selecting distribution of the bargain sale plan data after approving the bargain sale plan. The acquisition button 585 is a button for selecting acquisition of the output data. The updating button 586 is a button for selecting the data updating.

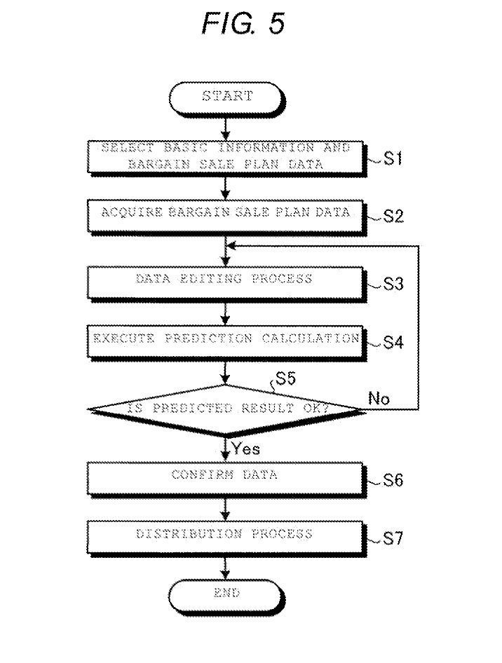

Next, a flow of an updating process of the bargain sale plan data in the plan mode using the demand prediction setting screen 50 will be described with reference to a flowchart of FIG. 5.

As shown in FIG. 5, first, basic information such as the store or the date, and the target bargain sale plan data are selected (Step S1).

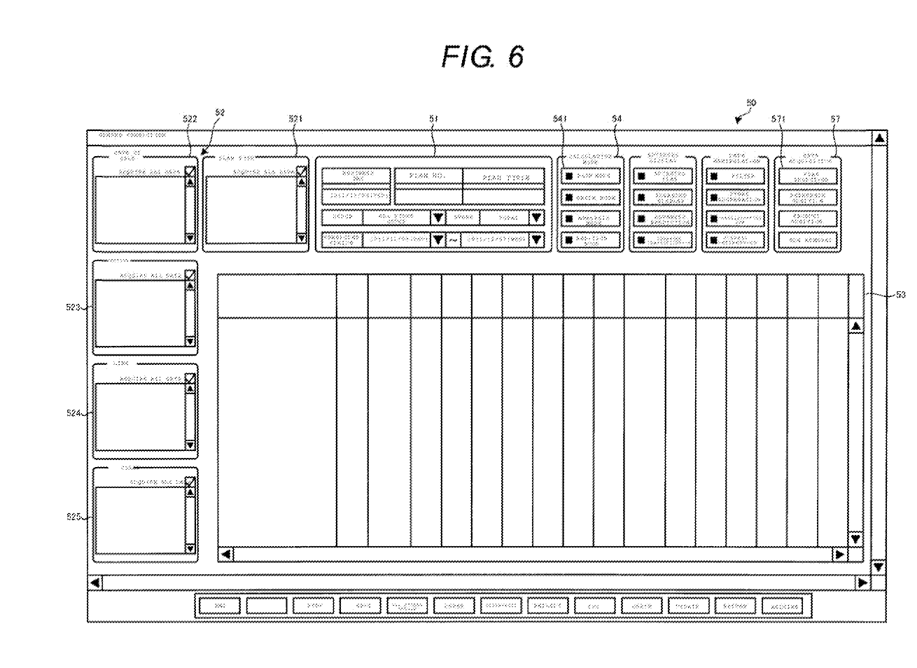

The input receiving unit 114 causes an initial screen of the demand prediction setting screen 50 shown in FIG. 6 to be displayed, and selects and inputs various information items such as the acquisition group and the store, the date (business day), and the prediction period, except for the plan number and the plan title in the basic information area 51. Since the data display area 53 is in a state where no data is displayed, no buttons are displayed on each of the selection buttons 521 to 525 in the acquisition and display data selection area 52.

In addition, when the plan mode button 541 of the calculation mode button area 54 is manipulated in the initial screen of the demand prediction setting screen 50 shown in FIG. 6, the modification of the bargain sale plan is selected, and the plan selection button 571 in the data acquisition/removal button area 57 is turned into a state of being editable.

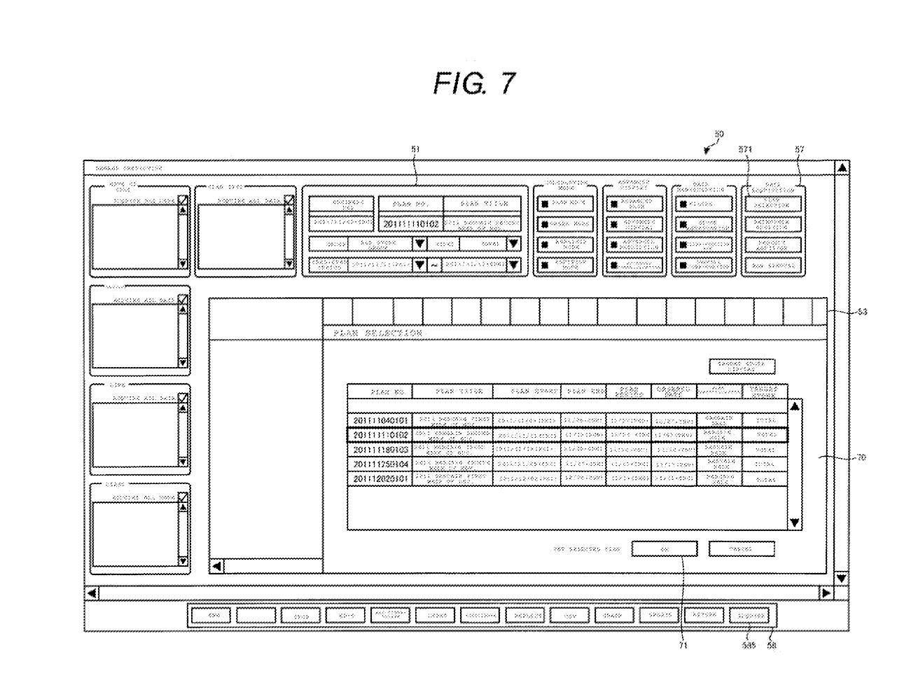

Next, when the plan selection button 571 is manipulated, a plan selection screen 70 is displayed as a popup in a state of being overlapped on the data display area 53 of the demand prediction setting screen 50 shown in FIG. 7. The plan number, the plan title, the plan period, and the like for each bargain sale plan data item are displayed on the plan selection screen 70. When an arbitrary plan number is selected from the plan data items displayed on the plan selection screen 70 and an OK button 71 is manipulated, the plan number and the plan title are set in the basic information area 51.

Next, as shown in FIG. 5, the input receiving unit 114 acquires the bargain sale plan data to be a target (Step S2).

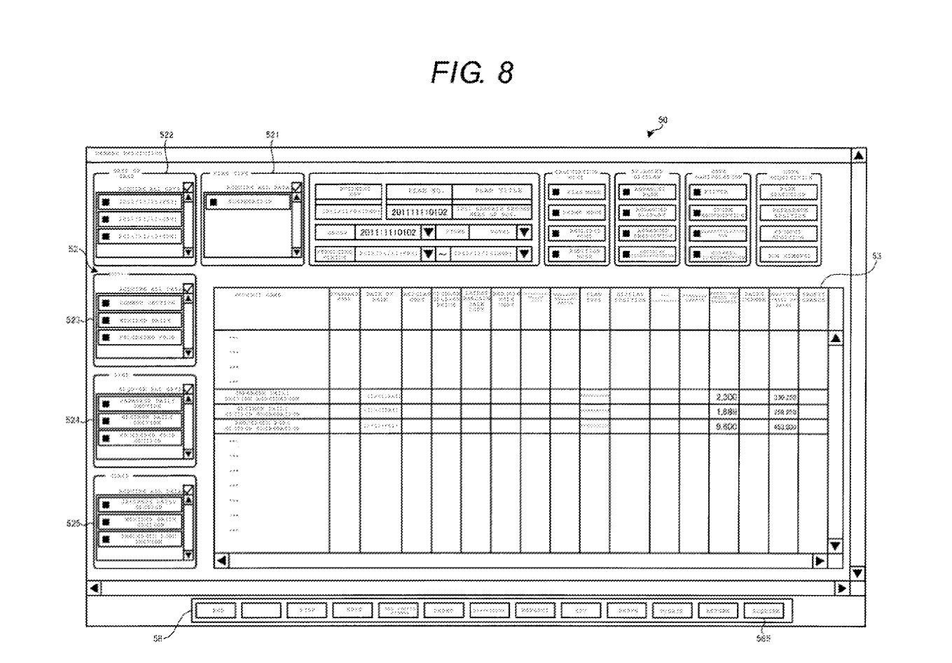

In the demand prediction setting screen 50 shown in FIG. 7, when the acquisition button 585 in the navigation button area 58 is manipulated, the input receiving unit 114 immediately starts acquisition of the aggregation data according to the plan number. When the acquisition process of the aggregation data ends, the acquired aggregation data is displayed in the data display area 53 of the demand prediction setting screen 50 as shown in FIG. 8. In addition, the data display area 53 is turned into a state where data is displayed, all buttons corresponding to the products included in the aggregation data in the data display area 53 are displayed on each of the selection buttons 521 to 525 in the acquisition and display data selection area 52. In the initial state, the “aggregation” button is displayed on the plan type selection button 521.

FIG. 8 shows a case in which the products included in the plan selected in FIG. 7 belong to a “western daily section”, a “Japanese daily section”, and a “processed food section”, for example. As shown in FIG. 8, the “western daily section”, the “Japanese daily section”, and the “processed food section”, are automatically selected on each of the selection buttons 523 to 525 in the acquisition and display data selection area 52.

FIG. 8 shows the sections to which the products included in the plan selected in FIG. 7 belong, for example. However it is not limited thereto. For example, all sections may be previously displayed and the sections to which the products included in the plan belong may be differentiated from the other section. As a method of differentiating from the other section, various methods such as changing colors or attaching marks are considered.

By doing so, when transmitting a large amount of data through the Internet, it is possible to reduce the size of the data to a necessary minimum size of data and as a result to shorten the data transmission time.

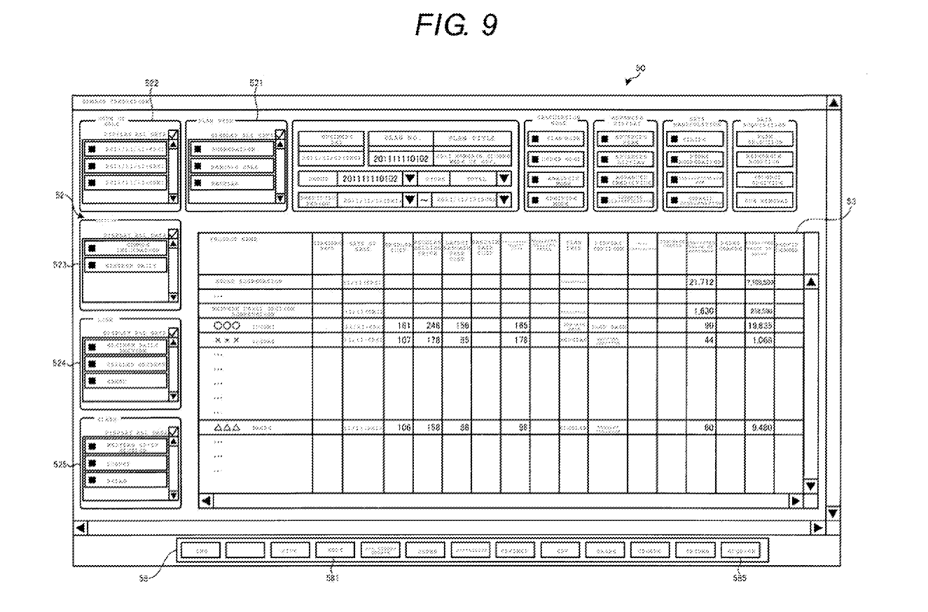

Then, after the acquisition of the aggregation data ends, the acquisition of the data for editing starts. First, narrowing-down of data extraction conditions is performed. The narrowing-down of the data extraction conditions is performed by manipulating the buttons displayed on each of the selection buttons 521 to 525 in the acquisition and display data selection area 52. When the buttons of the desired data extraction conditions (date of sale, plan type, section, and the like) displayed on selection buttons 521 to 525 are selected and the acquisition button 585 in the navigation button area 58 is selected, the data items which coincide with the data extraction conditions (date of sale, plan type, section, and the like) are acquired from the plan master database. The acquired data items are displayed in the data display area 53 of the demand prediction setting screen 50 as shown in FIG. 9.

In the demand prediction setting screen 50 shown in FIG. 9, since the buttons displayed in the selection buttons 521 to 525 in the acquisition and display data selection area 52 correspond to a product included in the acquired aggregation data, the buttons other than the extracted conditions are not displayed. In addition, with the manipulation of the buttons displayed on the selection buttons 521 to 525 in the acquisition and display data selection area 52, re-acquisition of the data obtained by further narrowing-down of the data extraction conditions can be performed. For example, not only the section, but the line or the class also can be set as the data extraction conditions.

When the acquisition button 585 is manipulated, the data extraction conditions are stored in a memory region in the RAM 103. This is for the usage in the re-acquisition when updating during data editing, which will be described later.

As described above, in a state where the acquisition of the bargain sale plan data which is a target after narrowing down of the data extraction conditions ends, when the editing button 581 in the navigation button area 58 is manipulated, the state is turned into a state where the data editing can be performed.

Next, as shown in FIG. 5, the input receiving unit 114 executes an editing process with respect to the bargain sale plan data to be a target (Step S3).

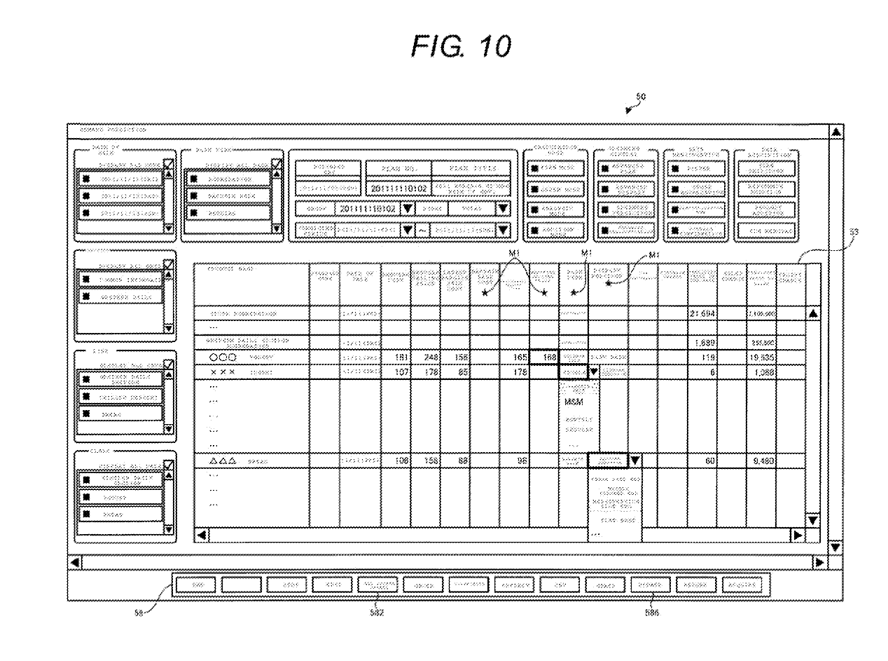

An example of the data editing will be described. As shown in the demand prediction setting screen 50 shown in FIG. 10, the editable columns of the bargain sale plan data displayed in the data display area 53 are displayed to be differentiated by attaching marks M1 such as stars. As described above, the editable items are made noticeable at first sight by attaching the marks M1. There is no limitation to attaching the marks M1, and the editable columns of the bargain sale plan data may be differentiated in display by changing the color thereof.

In the embodiment, as shown in FIG. 10, the “bargain sale cost”, the “modified selling price”, the “plan type”, the “display position”, and the like are set as the editable columns of the bargain sale plan data. The “bargain sale cost”, the “modified selling price”, and the like are subject to input of the data which becomes variable factors by input of numerical values. The modified value has a priority and is used as fixed data. In addition, the “plan type”, the “display position”, and the like are subject to input of the data which becomes variable factors by selecting the desired character string from the selection list.

In the embodiment, the display data items can be narrowed down by manipulating the buttons displayed on the selection buttons 521 to 525 in the acquisition and display data selection area 52. For example, by manipulating one button displayed in the line selection button 524, only the data of the product classification category (level 2) corresponding to the manipulated button is displayed.

By doing so, since it is possible to further narrow down the data displayed in the data display area 53 of the demand prediction setting screen 50, the screen generation time can be shortened. In addition, even in a case of using a portable device having a small-sized screen such as a tablet terminal as a display target device of the demand prediction setting screen 50, it is possible to reduce an amount of scrolling or a movement amount. Accordingly it is possible to provide excellent usability.

As described above, when the updating button 586 in the navigation button area 58 is manipulated after the data input for editing of the bargain sale plan data ends, as shown in FIG. 5, the prediction calculation unit 113 writes the modified bargain sale plan data in an output table in the RAM 103 and executes the prediction calculation (Step S4). Herein, the data written in the output table is an input value, an input character string, and a code corresponding to the input characteristic string.

When the “store” in the basic information area 51 shows “total”, this assumes the bargain sale plan modification of a buyer of the head office. Therefore, when the all stores update button 582 in the navigation button area 58 is manipulated, the bargain sale plan data of each store which is the plan target can be updated with the modified bargain sale plan data.

After the updating (re-prediction calculation), the bargain sale plan data is acquired again. However, for the data extraction conditions at that time, the data extraction conditions during the data acquisition previously stored in the memory region in the RAM 103 are used. With the acquired data, a display starting row in the data display area 53 is also displayed again with the value before the updating, according to the conditions of the selection buttons before the updating.

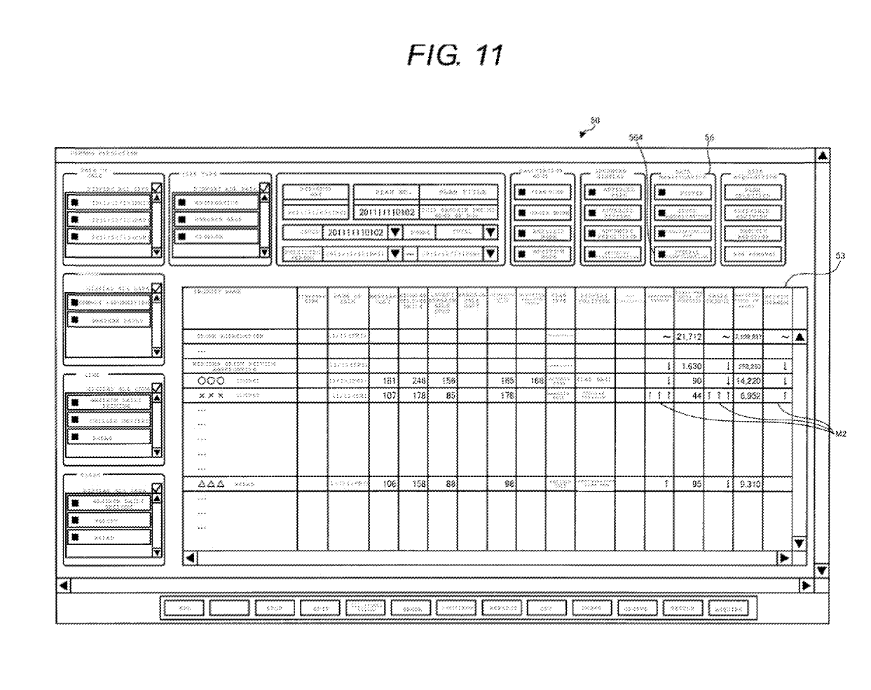

After the updating (re-prediction calculation), as shown in FIG. 11, the updated “predicted value of purchase”, “predicted value of sales”, and “predicted value of profit” (not shown) are displayed on the demand prediction setting screen 50. The predicted values of the products which are not directly subject to changing plan conditions, also change according to the interaction.

In addition, in the demand prediction setting screen 50 shown in FIG. 11, conceptual marks M2 representing amounts of change in an initial predicted value of the purchase, an initial predicted value of sales, and an initial predicted value of profit—which are predicted values with respect to the recommended values—are also displayed in the “purchase change”, the “sales change”, and the “profit change”. In the embodiment, the amounts of change are shown by directions of arrows and numbers. A downward arrow shows a “decrease”, and an upward arrow shows an “increase”. There is no limitation to performing the display of the marks M2 showing the amounts of the change, and the amounts of change may be abstracted and shown by coloring of the rows of the “purchase change”, the “sales change”, the “profit change”, and the like. For example, when the predicted value of purchase, the predicted value of sales, and the predicted value of profit as the predicted results are increased, the row may be displayed with blue, and when the predicted values thereof are decreased, the row may be displayed with red.

As described above, by changing the state of the rows in the data display area 53 according to the increase and decrease (amounts of change) in the predicted value of purchase, the predicted value of sales, and the predicted value of profit, it is possible to easily generate the predicted results.

Next, as shown in FIG. 5, the input receiving unit 114 determines whether or not the predicted results are to be employed (Step S5).

In a case where the predicted results are not the desired results, when it is determined that the editing button 581 in the navigation button area 58 is manipulated (No of Step S5), the process returns to Step S3 and the input receiving unit 114 is set to the state in which the data editing can be performed again.

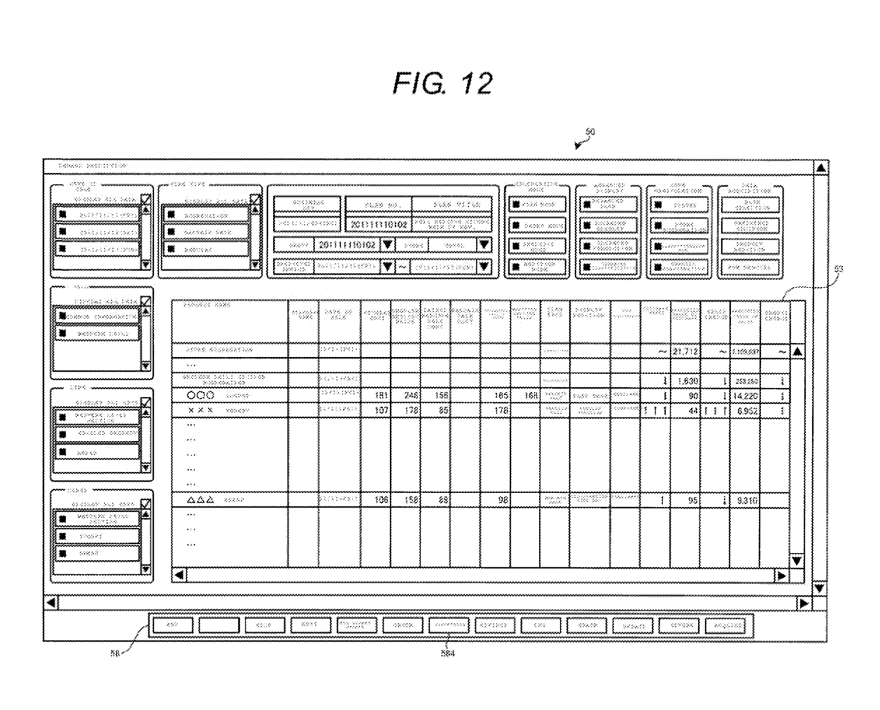

On the other hand, in a case where the predicted results are the desired results, when it is determined that the overall confirmation button 564 in the data manipulation button area 56 is manipulated (Yes of Step S5), it is possible to set the entire selected confirmable rows to “confirmed” states, as shown in the demand prediction setting screen 50 of FIG. 12 (Step S6). Herein, the confirmable rows are rows in which the “plan confirmation” item in the data display area 53 is empty. As described above, by performing overall confirmation of the plan data, the values of the output data of the entire stores which is the plan target are rewritten. Accordingly, since it is possible to perform overall confirmation, while it is necessary to confirm for each product, it is possible to significantly save time and effort of a user.

Finally, as shown in FIG. 5, when it is determined that the distribution button 584 in the navigation button area 58 is manipulated after the confirmation of the bargain sale plan data, the input receiving unit 114 distributes the bargain sale plan data to the bargain sale plan supporting system 121 (Step S7).

As described above, according to the data editing device of the embodiment, the buttons in the data selection area 52 are generated from the target columns of the product data displayed in the data display area 53, and it is possible to easily determine the section to which the product of the plan (i.e., the product selected in the section selection after the plan selection) belongs. Accordingly, it is possible to simplify the data input when predicting the effects obtained by the bargain sale operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A device for generating a user interface for sales planning, comprising:
a data display generation unit configured to generate a graphical user interface (GUI) for an external device, the GUI including a data display area for displaying product sales data for a plurality of items that are included in a selected sales plan, the data display area having a first field that is editable and a second field that displays predicted sales data values which are updated when the first field is edited;
a data aggregation unit configured to aggregate product sales data of the plurality of items; and
a prediction calculation unit configured to calculate the predicted sales data values and update the predicted sales data values when the first field is edited, based on the product sales data for the plurality of items that have been aggregated in the data aggregation unit.

2. The device according to claim 1, wherein the sales plan is selected from one of a plurality of sales plans that are displayed in the data display area prior to displaying the product sales data for the plurality of items that are included in the selected sales plan.

3. The device according to claim 1, wherein the GUI further includes a data selection area configured to receive one or more inputs to filter the product sales data displayed in the data display area.

4. The device according to claim 3, wherein the product sales data displayed in the data display area is filtered according to product types or classes.

5. The device according to claim 1, wherein the GUI further includes a first button, which when selected, locks in the sales plan for subsequent distribution, and a second button, which when selected, allows for additional editing of the second field.

6. The device according to claim 1, wherein the first field is marked to indicate that values displayed therein are editable.

7. The device according to claim 1, wherein the predicted sales data values of the second field, when updated, are displayed next to marks that indicate whether the predicted sales data values increased or decreased.

8. A non-transitory computer-readable medium comprising instructions that cause a computer system to carry out a method of generating a graphical user interface (GUI) and updating the GUI based on selections made on the GUI, said method comprising:
generating the GUI that includes a data display area for displaying product sales data for a plurality of items that are included in a selected sales plan, the data display area having a first field that is editable and a second field that displays predicted sales data values which are updated when the first field is edited;
calculating predicted sales data values based on the product sales data for the plurality of items that have been aggregated in the data aggregation unit;
receiving changes to the first field; and
updating the predicted sales data values based on the product sales data for the plurality of items that have been aggregated in the data aggregation unit.

9. The non-transitory computer-readable medium according to claim 8, wherein the sales plan is selected from one of a plurality of sales plans that are displayed in the data display area prior to displaying the product sales data for the plurality of items that are included in the selected sales plan.

10. The non-transitory computer-readable medium according to claim 8, wherein the GUI further includes a data selection area configured to receive one or more inputs to filter the product sales data displayed in the data display area.

11. The non-transitory computer-readable medium according to claim 10, wherein the method further comprises:
filtering the product sales data displayed in the data display area according to product types or classes.

12. The non-transitory computer-readable medium according to claim 8, wherein the GUI further includes a first button, which when selected, locks in the sales plan for subsequent distribution, and a second button, which when selected, allows for additional editing of the second field.

13. The non-transitory computer-readable medium according to claim 8, wherein the method further comprises:
marking the first field to indicate that values displayed therein are editable.

14. The non-transitory computer-readable medium according to claim 8, wherein the method further comprises:
displaying the predicted sales data values of the second field, when updated, next to marks that indicate whether the predicted sales data values increased or decreased.

15. A method of generating a graphical user interface (GUI) and updating the GUI based on selections made on the GUI, said method comprising:
generating the GUI that includes a data display area for displaying product sales data for a plurality of items that are included in a selected sales plan, the data display area having a first field that is editable and a second field that displays predicted sales data values which are updated when the first field is edited;
calculating predicted sales data values based on the product sales data for the plurality of items that have been aggregated in the data aggregation unit;
receiving changes to the first field; and
updating the predicted sales data values based on the product sales data for the plurality of items that have been aggregated in the data aggregation unit.

16. The method according to claim 15, wherein the sales plan is selected from one of a plurality of sales plans that are displayed in the data display area prior to displaying the product sales data for the plurality of items that are included in the selected sales plan.

17. The method according to claim 15, wherein the GUI further includes a data selection area configured to receive one or more inputs to filter the product sales data displayed in the data display area.

18. The method according to claim 17, further comprising:
filtering the product sales data displayed in the data display area according to product types or classes.

19. The method according to claim 15, further comprising:
marking the first field to indicate that values displayed therein are editable.

20. The method according to claim 15, further comprising:
displaying the predicted sales data values of the second field, when updated, next to marks that indicate whether the predicted sales data values increased or decreased.
